(19) United States
(12) Patent Application Publication
(10) Pub. No.: US 2009/0272481 A1
(43) Pub. Date: Nov. 5, 2009

(54) METHOD AND DEVICE FOR THE PRODUCTION OF FILM BAGS

(76) Inventors: Jochen Brauer, Lohne (DE); Marcus Kujat, Osnabruck (DE); Detlef Stoppelmann, Steinfeld (DE); Darius Maseiker, Diepholz (DE)

Correspondence Address: COLLARD & ROE, P.C., 1077 NORTHERN BOULEVARD, ROSLYN, NY, 11576, US

(21) Appl. No.: 11/920,527

(22) PCT Filed: May 17, 2006
(86) PCT No.: PCT/EP2006/004633

§ 371 Date: Feb. 5, 2008

(30) Foreign Application Priority Data
May 18, 2005 (DE) 10 2005 022 742.2

(51) Int. Cl. A44B 19/16; B29C 63/04

(52) U.S. Cl. 156/66; 156/475

(57) ABSTRACT

The invention relates to a method and a device for producing foil bags comprising V-shaped inserted lateral folds and a reclosing mechanism with a slide in a top filling hole. The inventive method encompasses the following steps: window-shaped blanks (10) which delimit the top end of the subsequently formed lateral folds as well as slide blanks (11) are introduced into a planar sheeting. Reclosing mechanisms (6) that are composed of two superimposed and interconnected profiled strips and a slide are placed on the planar sheeting (2) perpendicular to the direction of the sheeting in such a way that the slides lie inside the slide blanks (11). The reclosing mechanisms (6) are connected to the sheeting only at the ends. The sheeting (2) is then directed through a folding station (7) in which the sheeting is folded and lateral folds are molded thereinto. The reclosing mechanisms (6) are joined to the sheeting by means of a sealing seam while the top end of the lateral folds is incorporated thereinto. The superimposed foil layers are finally joined by means of additional sealing seams so as to obtain a run (16) of bags which comprises bag-shaped sections and from which individual foil bags (17) are cut off.

The invention relates to a method as well as a device for the production of film bags that have side folds placed in the shape of a V, and a re-closure having a slide, in a head-side filling opening.

The re-closure of the film bags consists of two profile strips and a slide that couples the profile strips. One of the profile strips is connected with one front side of the bag, and the other profile strip can be connected with the other front side, after the film bag has been filled. The film bags, which lie flat at first, are filled with filled-in goods in bag filling devices. Filling takes place at the head of the bags. The filled-in goods are introduced in an opening that is still present between the re-closure and a front side of the bag. Afterwards, this opening is closed by means of a sealing seam. Film bags having the characteristics described are used for packaging animal food, among other things.

Film bags having the characteristics described are known from DE 202 07 333 U1. Their production is complicated. Subsequent to the bag production, the re-closures are applied in a downstream system part. For this purpose, a film section of the film bags, which have already been produced, is flipped open in the head region of the bag, a re-closure is laid onto the film web that lies underneath, and connected with the latter. Afterwards, the flipped-open film section has to be folded back, and the sealing seams, which are still missing, have to be applied. The devices required for application of the re-closures must perform several process steps and have a significant space requirement. There is a need to integrate the application of re-closures into usual bag production methods, avoiding a downstream system part.

With this background, the invention is based on the task of indicating a method in which the application of the re-closures takes place during the continuous web advance of a planar film web, before shaping of the bags.

The object of the invention and solution for this task is a method for the production of film bags according to claim 1. The method according to the invention comprises the following method steps:
a) window-shaped punch-outs that delimit the upper end of the side folds formed later, as well as slide punch-outs, are made in a planar film web;
b) re-closures consisting of two profile strips that lie on top of one another and are connected with one another, as well as a slide that engages over closure edges of the profile strips in the manner of a rider, are laid onto the planar film web, crosswise to the web direction, in such a manner that the slides lie in the slide punch-outs, and are connected with the film web at the ends;
c) subsequently, the film web is guided through a folding station, in which the film web is folded, and front surfaces as well as side folds are formed;
d) the re-closures are connected with one front surface by means of a sealing seam, with the inclusion of the upper end of the side folds;
e) the film plies that lie on top of one another are connected, with additional sealing seams, to form a continuous bag roll consisting of bag-shaped sections;
f) film bags are separated from the continuous bag roll.

The invention is based on the deliberation of applying the re-closures onto the planar film web before the film web passes through a folding station, in which it is folded and side folds are formed. The application of the re-closures, according to the invention, can be integrated into existing bag production systems, whereby the method according to the invention makes use of the punching and folding devices that are already present in a bag production system. In this connection, however, the technical problem must be solved that the re-closures can shift as the film web is transported through the system, particularly in the folding devices, since the re-closures are connected with the film web only at their ends, at first. An opening must remain between the profile strips of the re-closure and the film web, so that the bags can be filled at their head-side end. Only after the bags are filled is this opening closed by means of bonding the profile strip to the front side of the film bag. The technical problem described is solved, according to the invention, by means of the method steps a) and b). According to the invention, slide punch-outs are made in the film web, which lie precisely at the position of the slides, and prevent shifting of the re-closures and the slide, counter to the film running direction, as the web passes through the bag production system, particularly also as the web passes over the guide plates of the folding station. The slides are essentially fixed in place in the assigned slide punch-outs. In the simplest case, the slide punch-outs are round holes whose diameter is adapted to the slide geometry.

According to another embodiment of the method according to the invention, weakening lines are made in the planar film web, crosswise to the longitudinal web direction, which are disposed at the level of the window-shaped recesses and extends over the web width, with the proviso that a non-weakened film region having a width of 5 mm to 50 mm remains between the weakening lines and the window-shaped recesses, in each instance. The weakening lines are, for example, a perforation produced by means of punching, or a weakening line produced by means of laser technology. The film web is guided into the folding station in such a manner that the edges of the folding tools lie against the non-weakened film regions, between the perforation/weakening line and the recesses. Folding of the film web into a tubular web takes place using triangular folding plates, whereby the window-shaped punch-outs are guided centrally over the triangular plates.

Continuous longitudinal sealing seams can be applied along the edges of the continuous bag roll, in the longitudinal web direction. In this connection, it is practical if punch cuts are made in the longitudinal sealing seams, which cuts follow the weakening lines.

The bags can be separated from the continuous bag roll in different ways. One embodiment of the method according to the invention provides that the bags are separated from the continuous bag roll by means of a separating cut, whereby a strip-shaped section remains between the cut edge and the adjacent weakening line, which section covers the re-closure. The strip can be utilized as a tamper-proof closure, if the double-ply strip is sealed with a crosswise sealing seam at its upper edge, after the film bag has been filled. When the film bag is used for the first time, the strip on the top has to be removed, causing the re-closure at the upper edge of the film bag to be exposed. If the sealing seam of the waste strip is undamaged, this ensures that the film bag has not been opened yet.

Within the scope of the method according to the invention, the bags can also be separated from the continuous bag roll along the weakening lines, in that a tensile force is exerted on the bag to be separated, in the longitudinal web direction, for example by pulling on the web. The bags are torn off from the continuous bag roll, along the weakening line. A residual piece remains on the bottom-side end of the film bags that are torn off, which piece can be utilized as material for shaping and sealing the bag bottom.

Another embodiment of the method according to the invention provides that the bags are separated from the continuous bag roll by means of a separating cut, and that a strip-shaped section consisting of two film plies remains between the cut edge and the re-closure, which section covers the re-closure, and that the film plies that cover the re-closure are removed from the bag using a cutting blade, in order to expose the slide of the re-closure. In this embodiment of the method, film sections that project after bag folding and bonding are removed by flipping them up and cutting them off. In this way, smooth film edges are obtained, which are not slanted at the longitudinal sealing seams.

Another object of the invention is a device for implementing the method, having
an unwinding station for pulling a planar film web from a film roll,
a punching device having punching tools that produce window-shaped punch-outs in the planar film web, which delimit the upper end of side folds,
a feed device for pre-finished re-closures consisting of two profile strips that lie on top of one another and are connected with one another, in each instance, as well as a slide that engages over closure edges of the profile strips in the manner of a rider,
a folding station having folding devices for folding the film web into a double ply, and for placing V-shaped side folds,
sealing stations for crosswise sealing and longitudinal sealing of the folded material web, and
a station for separating film bags from the material web,
   whereby the punching device disposed in front of the folding station has additional punching tools that makes slide punch-outs in the planar film web, and whereby a device is provided between the punching device and the folding station, which positions the re-closures on the planar film web, crosswise to the longitudinal web direction, in such a manner that the slides of the re-closures lie in the assigned slide punch-outs.

In the following, the invention will be explained using a drawing that shows an embodiment merely as an example. This schematically shows:

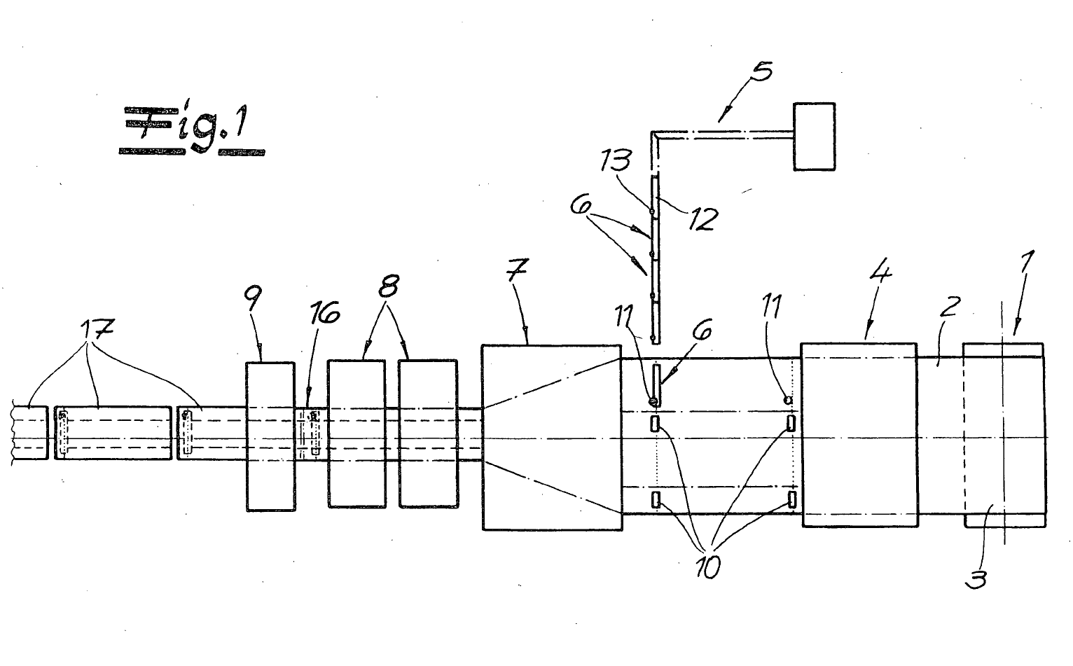

FIG. 1 the block schematic of a system for the production of film bags that have side folds placed in the shape of a V, and a re-closure having a slide, in a head-side filling opening,

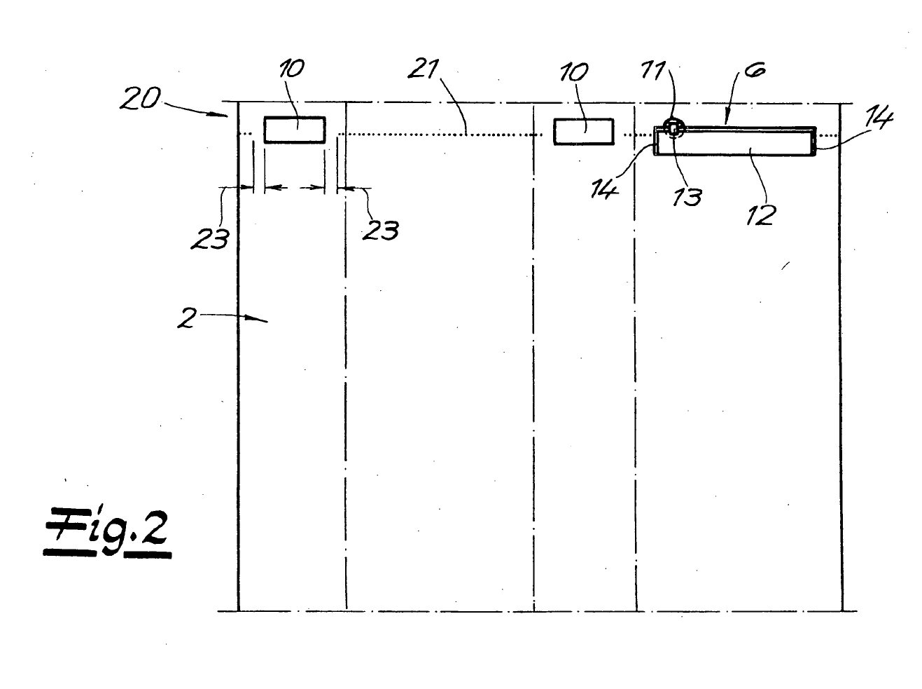

FIG. 2 a detail of a planar film web having punch-outs made according to the invention, before the film web is passed to a folding station of the system shown in FIG. 1,

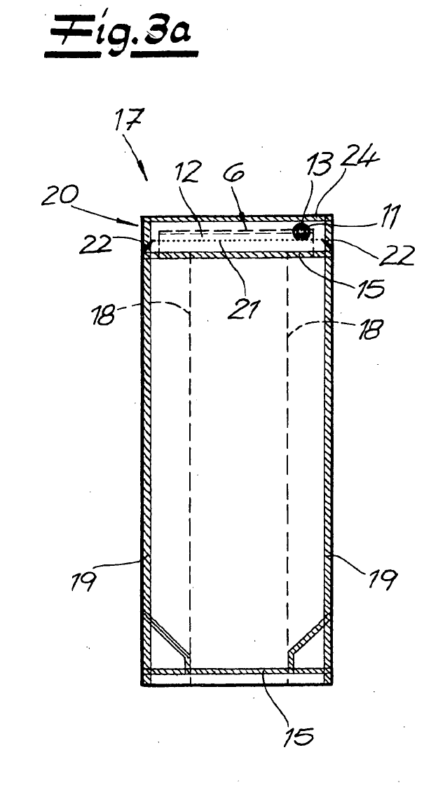

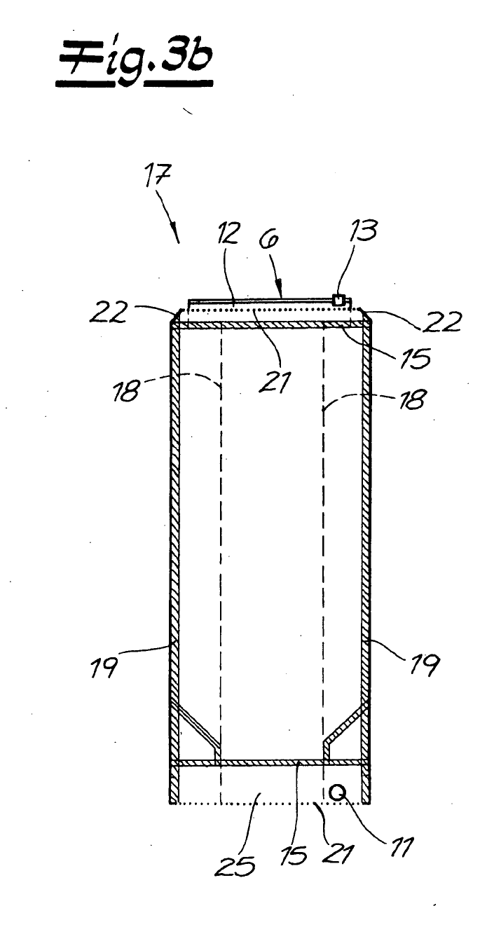

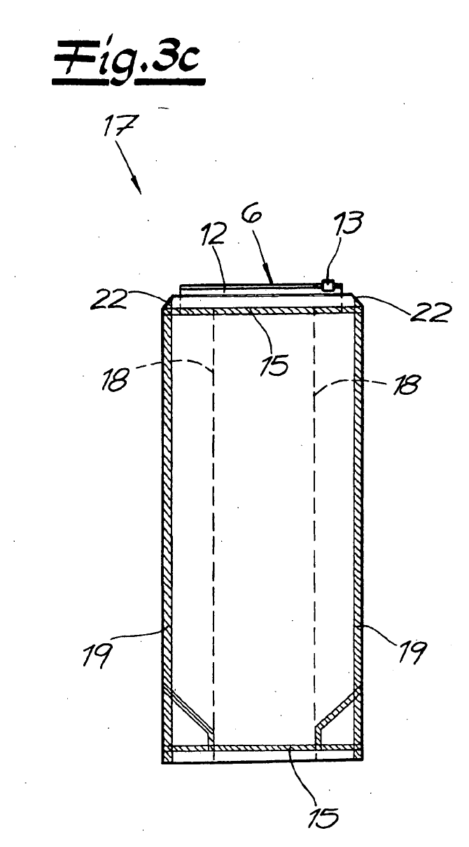

FIG. 3a to 3c method products that can be produced using the system shown in FIG. 1.

The system shown in FIG. 1 comprises an unwinding station 1 for pulling a planar film web 2 from a film roll 3; a punching device 4; a feed device 5 for pre-finished re-closures 6; a folding station 7 having folding devices for folding the film web 2 into two plies, and for placing V-shaped side folds; sealing stations 8 for crosswise sealing and longitudinal sealing of the folded material web; as well as a station 9 for separating film bags from the material web. Window-shaped punch-outs 10 that delimit the upper end of the side folds that are formed later, as well as slide punch-outs 11, are made in the planar film web 2 in the punching device 4 (FIG. 2). The re-closures 6 fed to the material web consist of two profile strips 12 that line on top of one another and are connected with one another, as well as a slide 13, which engages over closure edges of the profile strips in the manner of a rider. The pre-finished re-closures 6 are laid onto the planar film web 2 in such a manner that the slides 13 lie in the slide punch-outs 11, and are then connected with the film web 2 at their ends 14. FIG. 2 shows the film web with re-closures 6 lying on it, before the film web is passed to the folding station 7. In the folding station 7, the film web is folded to form a double-ply material web, and side folds are placed. In subsequent sealing stations 8, the re-closures 6 are connected with one front surface of the bag, by means of a sealing seam, with inclusion of the upper end of the side folds, and the film plies that are lying on top of one another are connected with additional sealing seams 15, to form a continuous bag roll 16 that consists of bag-shaped sections. In a final station 9, film bags 17 are separated from the continuous bag roll 16.

The method product is shown in FIG. 3a. The film bag 17 shown in FIG. 3a has two front sides, side folds 18 placed in V shape between the front sides, and a re-closure 6 at a head-side opening of the bag. The re-closure 6 consists of two profile strips 12 and a slide 13 that couples the profile strips. One of the profile strips 12 is connected with a front side of the bag. The other profile strip can be connected with the other front side after the bag has been filled. The film plies of the bag that lie on top of one another are connected with crosswise and longitudinal sealing seams 15 at the bottom side and along the edges of the side folds 18, whereby the longitudinal sealing seams 19 that run along the side folds 18 extend from the bottom to the upper edge of the bag. The re-closure 6, including its slide 13, is disposed within the bags, at a distance from the upper bag edge. One front side of the bag contains a slide punch-out 11 adapted to the dimensions of the slide 13, in which the slide 13 is positioned before first-time use of the bag.

The front sides of the film bag 17 have a strip-shaped section 20 that covers the re-closure, at the upper end of the bag, which section can be torn off along a weakening line 21 disposed approximately at the level of the slide or below the slide. In the exemplary embodiment, the weakening line 21 consists of a perforation produced by means of punching. The weakening line can also be produced by means of laser technology, if an optically appealing torn edge is desired. Punched lines 22 that extend through the longitudinal sealing seams 19 all the way to the outer edges of the bag follow the ends of the perforation line 21. The side folds 18 end below the perforation line 21. The strip-shaped section 20 can be removed from the film bag 17 along the perforation line 21 and the subsequent punched lines 22. When this is done, the re-closure 6 is exposed.

The perforation line 21 is made in the planar material web and is shown in FIG. 2. It can be seen from FIG. 2 that the perforation line 21 extend over the web width, with the proviso that a non-perforated film region 23, having a width of 5 mm to 50 mm, remains between the perforation and the window-shaped recesses 10, in each instance. For the production of the film bags 17 shown in FIG. 3a, the bags are separated from the continuous bag roll 16 by means of a separating cut, whereby a strip-shaped section remains between the cut edge and the adjacent perforation line 21, which section covers the re-closure.

The film bags shown in FIG. 3a are used, for example, for packaging animal food. Filling takes place at the head of the bag. The filled-in goods are introduced into an opening that is still present between the re-closure and a front side of the film bag. Afterwards, this opening is closed by means of a sealing seam. In addition, the upper edge of the strip-shaped section that is torn off during first-time use of the film bag is sealed as a tamper-proof closure. Sealing takes place with a sealing seam 24 that connects the film plies. In the bag filling system, the bottom of the film bag is also folded to form a stand-up bottom.

In the case of the embodiment of the film bag shown in FIG. 3b, the slide 13 of the pre-finished film bag is exposed. This is achieved, in the system shown in FIG. 1, in that the bags are separated from the continuous bag roll along the perforation line 21. A residual piece 25 remains at the bottom-side end, which piece contains the slide punch-out 11 and is folded down, together with the bottom fold, after the bag has been filled.

It is not compulsory to make the perforation line 21. For the production of the film bag shown in FIG. 3c, the bags are separated from the continuous bag roll 16 by means of a separating cut. When this is done, a strip-shaped section consisting of two film plies remains between the cut edge and the re-closure 6, which section covers the re-closure 6. The film plies that cover the re-closure are separated in the final work station, by folding them up and cutting them off. As a result, the top film edges of the bag are smooth and do not have any perforation tear-off points.

1. Method for the production of film bags that have side folds placed in the shape of a V, and a re-closure having a slide, in a head-side filling opening, having the following method steps:
a) window-shaped punch-outs that delimit the upper end of the side folds formed later, as well as slide punch-outs, are made in a planar film web;
b) re-closures consisting of two profile strips that lie on top of one another and are connected with one another, as well as a slide that engages over closure edges of the profile strips in the manner of a rider, are laid onto the planar film web, crosswise to the web direction, in such a manner that the slides lie in the slide punch-outs, and are connected with the film web at their ends;
c) subsequently, the film web is guided through a folding station, in which the film web is folded, and front surfaces as well as side folds are formed;
d) the re-closures are connected with one front surface by means of a sealing seam, with the inclusion of the upper end of the side folds;
e) the film plies that lie on top of one another are connected, with additional sealing seams, to form a continuous bag roll consisting of bag-shaped sections;
f) film bags are separated from the continuous bag roll.

2. Method according to claim 1, wherein weakening lines are made in the planar film web, crosswise to the longitudinal web direction, which are disposed at the level of the window-shaped recesses and extend over the web width, with the proviso that a non-weakened film region having a width of 5 mm to 50 mm remains between the weakening lines and the window-shaped recesses, in each instance.

3. Method according to claim 2, wherein continuous longitudinal sealing seams are made along the edges of the continuous bag roll, in the longitudinal web direction, and wherein punch cuts are made in the longitudinal sealing seams, which cuts follow the weakening lines.

4. Method according to claim 2, wherein the bags are separated from the continuous bag roll by means of a separating cut, whereby a strip-shaped section remains between the cut edge and the adjacent weakening line, which section covers the re-closure.

5. Method according to claim 2, wherein the bags are separated from the continuous bag roll along the weakening lines.

6. Method according to claim 1, wherein the bags are separated from the continuous bag roll by means of a separating cut, and a strip-shaped section consisting of two film plies remains between the cut edge and the re-closure, which section covers the re-closure, and wherein the film plies that cover the re-closure are removed from the bag with a cutting blade, in order to expose the slide of the re-closure.

7. Device for implementing the method according to claim 1, having
an unwinding station (1) for pulling a planar film web (2) from a film roll (3),
a punching device (4) having punching tools that produce window-shaped punch-outs (10) in the planar film web (2), which delimit the upper end of side folds,
a feed device (5) for pre-finished re-closures (6) consisting of two profile strips (12) that lie on top of one another and are connected with one another, in each instance, as well as a slide (13) that engages over closure edges of the profile strips in the manner of a rider,
a folding station (7) having folding devices for folding the film web into a double layer, and for placing V-shaped side folds (18),
sealing stations (8) for crosswise sealing and longitudinal sealing of the folded material web, and
a station (9) for separating film bags (17) from the material web,
whereby the punching device (4) disposed in front of the folding station (7) has additional punching tools that make slide punch-outs (11) in the planar film web (2), and whereby a device is provided between the punching device (4) and the folding station (7), which device positions the re-closures (6) on the planar film web (2), crosswise to the longitudinal web direction, in such a manner that the slides (13) of the re-closures (6) lie in the assigned slide punch-outs (11).
